(19) United States
(12) Patent Application Publication
(10) Pub. No.: US 2026/0197177 A1
(43) Pub. Date: Jul. 9, 2026

(54) SYSTEM AND METHOD FOR CONTINUOUS DATA LINEAGE CAPTURE AND REPLAY IN REGULATED DATA PIPELINES

(71) Applicant: V Balamuralidhar SARABU, Frisco, TX (US)

(72) Inventor: V Balamuralidhar SARABU, Frisco, TX (US)

(21) Appl. No.: 19/556,950

(22) Filed: Mar. 4, 2026

(51) Int. Cl. H04L 9/32; G06F 1/12; G06F 16/25

(52) U.S. Cl. CPC H04L 9/3236; G06F 1/12; G06F 16/258

(57) ABSTRACT

A system and method for continuous data lineage capture and deterministic replay in regulated data pipelines are disclosed. The system comprises a data ingestion interface, a transformation interception unit positioned between a pipeline execution environment and a data storage resource, a metadata extraction processor configured to generate detailed lineage event records, a secure time synchronization unit configured to assign cryptographically verifiable timestamps, a cryptographic chaining processor configured to create a sequentially linked tamper-evident integrity chain, and an immutable lineage storage unit configured as an append-only persistent repository. The system further comprises a lineage graph construction processor configured to generate directed dependency representations of datasets, transformation operations, authorization contexts, and policy evaluations, and a deterministic replay processor configured to reconstruct historical runtime environments and reproduce prior outputs based on retrieved lineage event records.

### FIELD OF THE INVENTION

The present disclosure relates generally to data processing systems deployed in regulated computing environments and, more particularly, to a system, method, and dedicated machine structure configured for continuous capture, cryptographically verifiable preservation, deterministic reconstruction, and replay of data lineage across regulated data pipelines.

### BACKGROUND OF THE INVENTION

In regulated domains including financial services, healthcare informatics, industrial automation, and governmental data management, regulatory compliance requires complete traceability of data transformations from source ingestion to final output artifacts. Conventional logging systems record discrete events or snapshots; however, such systems fail to guarantee complete transformation reproducibility, fail to cryptographically bind execution context with transformation logic, and lack deterministic replay capability under distributed and asynchronous processing conditions. Existing pipeline orchestration frameworks typically provide metadata tracking but do not ensure immutable lineage continuity, hardware-anchored provenance integrity, or replayable execution states that satisfy audit-grade verification thresholds.

Regulated environments impose requirements for auditability, tamper-evidence, reproducibility, time synchronization, access control enforcement, and cryptographic attestation. The absence of a continuous lineage capture mechanism integrated at the processing fabric level creates risk of compliance violations, incomplete forensic reconstruction, and regulatory penalties. The present disclosure addresses these deficiencies by introducing a specialized machine and coordinated processing method for continuous lineage capture and replay with hardware-backed integrity enforcement.

Modern data-driven enterprises operate increasingly complex data pipelines that ingest, transform, enrich, aggregate, and distribute information across heterogeneous computing environments. In regulated sectors such as banking, insurance, healthcare, pharmaceuticals, telecommunications, energy utilities, and public administration, these pipelines are subject to strict compliance obligations requiring traceability, reproducibility, and accountability. Regulations often mandate that organizations demonstrate the origin of data, the transformations applied to it, the logic governing decision-making outputs, and the identity of actors interacting with the system. As data volumes grow and processing architectures shift toward distributed, cloud-native, and event-driven paradigms, maintaining continuous and verifiable data lineage across the full lifecycle of information has become a technically demanding challenge. Existing solutions attempt to address lineage tracking through metadata management platforms, logging frameworks, workflow orchestration tools, and data catalog systems; however, these approaches exhibit structural and architectural limitations that hinder their suitability for highly regulated environments.

Traditional extract-transform-load (ETL) tools introduced rudimentary lineage features by recording job-level metadata such as source tables, destination tables, and transformation scripts. These solutions typically rely on configuration files or manually defined mappings that describe data flow relationships. While such metadata provides coarse-grained visibility into data movement, it does not capture fine-grained transformation semantics at the execution level. In many cases, only the high-level workflow structure is recorded, without preserving runtime parameters, dynamic schema evolution events, conditional branching logic, or intermediate state transitions. As a result, the recorded lineage reflects an intended design rather than the actual executed behavior. This gap becomes critical in regulated environments where auditors require proof of what precisely occurred during execution rather than what was planned.

Workflow orchestration frameworks expanded visibility by representing pipelines as directed acyclic graphs (DAGs) and maintaining execution logs for each node. These systems provide scheduling metadata, status tracking, and error logs. However, orchestration logs are typically ephemeral and stored in operational databases optimized for short-term monitoring rather than long-term audit preservation. Logs may be rotated, truncated, or overwritten, thereby undermining historical completeness. Moreover, such logs generally lack cryptographic integrity guarantees. An administrator with sufficient privileges may alter or delete historical records without detection, creating compliance risk. Even when logs are archived, they often capture textual or semi-structured data that requires post-processing to reconstruct lineage relationships, leading to ambiguity and potential misinterpretation during audits.

Data catalog platforms emerged to centralize metadata about datasets, schemas, and usage patterns. These systems often integrate with databases and processing engines to infer lineage relationships by parsing query plans or analyzing metadata APIs. Although this approach improves automation compared to manual ETL documentation, it still depends on metadata extraction rather than real-time interception of executed transformations. Query parsing may fail in cases involving dynamic code generation, user-defined functions, or complex procedural logic. Furthermore, metadata synchronization between execution engines and catalog repositories may be delayed or inconsistent, producing partial lineage graphs. Because catalog systems generally operate as separate services rather than inline components of the processing fabric, they cannot guarantee that every transformation event is captured at the moment of execution.

Logging frameworks embedded within application code provide another common mechanism for traceability. Developers insert logging statements that record input parameters, intermediate values, or output results. While flexible, this approach depends heavily on developer discipline and coding standards. Omitted or inconsistent logging statements create blind spots. Logging statements may also be removed or altered in subsequent code revisions, compromising longitudinal consistency. Additionally, application-level logs do not inherently bind records to cryptographic signatures or secure timestamps. In distributed systems, logs generated by multiple nodes must be aggregated and synchronized, often relying on external log management platforms that may introduce delays, ordering ambiguities, or data loss during network disruptions.

Event sourcing architectures attempt to address reproducibility by recording state changes as immutable events. In such systems, application state can theoretically be reconstructed by replaying the sequence of events from inception. However, practical implementations frequently limit event storage to business-domain events rather than low-level transformation metadata. Environmental dependencies such as software library versions, configuration files, hardware states, and access control decisions are often excluded from the event stream. Consequently, replaying business events may not yield identical computational outputs if execution context has changed. Furthermore, event sourcing frameworks may not incorporate hardware-backed integrity or cryptographic chaining, leaving open the possibility of tampering in storage layers.

Distributed ledger technologies have been proposed as mechanisms for ensuring immutability of lineage records. By anchoring hashes of datasets or transformation logs onto blockchain networks, organizations seek to establish tamper-evidence. While this technique enhances integrity, it typically operates at a coarse granularity, anchoring periodic snapshots rather than continuous transformation events. Storing detailed lineage data directly on a blockchain is often impractical due to throughput limitations, storage costs, and latency constraints. Therefore, most implementations rely on off-chain storage combined with on-chain hash references, creating architectural complexity and potential synchronization challenges. Additionally, blockchain anchoring does not inherently provide deterministic replay capabilities; it only ensures that stored data has not been modified since anchoring.

Some regulatory compliance tools incorporate data versioning systems that capture snapshots of datasets at specific intervals. Version control mechanisms enable comparison between historical and current states. However, snapshot-based approaches incur substantial storage overhead, particularly for large-scale streaming datasets. More importantly, snapshots represent states rather than transformation paths. Without recording the precise sequence of operations applied between snapshots, organizations cannot reliably reconstruct intermediate outputs or demonstrate transformation logic under audit conditions. The absence of continuous capture between versions creates blind intervals during which critical transformations may have occurred.

Cloud-native data processing platforms introduce additional complexity due to elastic scaling, containerized execution, and microservices architectures. Containers may be instantiated and terminated dynamically, with ephemeral storage and transient network identities. Capturing lineage across such environments requires synchronizing metadata across rapidly changing instances. Existing monitoring solutions focus primarily on performance metrics and resource utilization rather than semantic transformation details. Moreover, time synchronization across distributed nodes remains challenging. Clock drift and network latency can cause inconsistent timestamp ordering, complicating reconstruction of event sequences. Without secure time attestation mechanisms, malicious actors could manipulate system clocks to alter perceived execution order.

Security information and event management (SIEM) systems aggregate logs for security monitoring and forensic analysis. While SIEM platforms provide correlation and anomaly detection capabilities, they are optimized for security events rather than comprehensive data transformation tracking. Their retention policies may prioritize recent activity, and storage compression techniques may discard granular contextual details. Additionally, SIEM systems typically lack deterministic replay engines capable of reconstructing data processing outputs exactly as originally generated.

Machine learning pipelines pose further challenges. Training data, feature engineering steps, model versions, hyperparameters, and hardware accelerators all influence model outputs. Existing experiment tracking tools record some of these parameters, but they often operate independently of broader enterprise data pipelines. Integration gaps between data engineering systems and model management tools can result in incomplete lineage chains. Reproducing a historical prediction may require reconstructing the precise combination of data preprocessing steps, library versions, and hardware acceleration states, which existing tools may not comprehensively capture.

Another limitation of existing solutions lies in access control traceability. While identity and access management systems log authentication and authorization events, these logs are rarely linked structurally to data transformation records. Consequently, demonstrating that a particular transformation was executed under a specific authorization context requires manual correlation across disparate systems. This fragmentation increases audit complexity and introduces opportunities for inconsistency.

The existing lineage and compliance solutions rely predominantly on metadata extraction, application-level logging, snapshot versioning, or periodic integrity anchoring. These approaches suffer from incomplete capture of runtime semantics, absence of cryptographic chaining at fine granularity, lack of hardware-backed timestamp integrity, insufficient protection against tampering, limited support for deterministic replay, and architectural fragmentation across distributed environments. As regulatory scrutiny intensifies and data processing architectures grow more dynamic and distributed, these drawbacks expose organizations to compliance risk and operational uncertainty. There remains a need for a unified, fabric-level system capable of continuously intercepting transformation events, cryptographically securing lineage records, synchronizing temporal order across distributed nodes, and enabling exact replay of historical pipeline states within controlled audit environments.

### SUMMARY OF THE INVENTION

The invention provides a dedicated data lineage capture and replay machine integrated within regulated data pipelines, comprising a structurally defined lineage acquisition interface, a transformation interception bus, a cryptographic state anchoring engine, a temporal coherence controller, a deterministic replay processor, and a secure persistent lineage vault. The machine operates in conjunction with a method that continuously intercepts data transformation events, encodes structural and semantic metadata, cryptographically binds execution context, and stores time-indexed lineage graphs that are replayable under deterministic reconstruction constraints.

The system ensures that every data mutation, schema evolution event, access control decision, technique transformation, parameter configuration, and environmental state dependency is captured in a structured lineage representation. The stored lineage representation is cryptographically chained and anchored to an immutable verification substrate. The replay subsystem reconstructs pipeline states using stored lineage graphs and execution artifacts to reproduce identical outputs under audit conditions.

The primary object of the present invention is to provide a system and method for continuous data lineage capture and replay in regulated data pipelines that ensures comprehensive, end-to-end traceability of data from initial ingestion through all intermediate transformations to final output artifacts. The invention seeks to establish a structurally integrated mechanism capable of intercepting and recording every transformation event occurring within a pipeline in real time, thereby eliminating blind spots associated with conventional metadata-based or log-dependent tracking solutions.

Another object of the invention is to provide a tamper-evident and cryptographically verifiable lineage recording mechanism that preserves the integrity and authenticity of transformation records. The invention aims to ensure that each lineage event is securely time-stamped, cryptographically chained, and protected against unauthorized modification, deletion, or retroactive alteration. By incorporating secure key storage and hardware-based time attestation, the system is intended to prevent manipulation of execution history and to provide non-repudiable proof of processing sequences for regulatory and forensic purposes.

A further object of the invention is to enable deterministic replay of regulated data pipelines using captured lineage information. The invention is directed toward reconstructing historical processing states in a controlled execution environment such that outputs generated during replay correspond identically to those originally produced. This objective includes the preservation of execution context, transformation logic identifiers, configuration parameters, schema states, environmental dependencies, and authorization contexts, thereby ensuring reproducibility at a granular level required for audit validation and compliance demonstration.

An additional object of the invention is to provide continuous and automated lineage graph construction that represents structural, semantic, and operational relationships among datasets, transformation operators, policy enforcement modules, and authorized actors. The invention seeks to dynamically generate and maintain directed lineage graphs reflecting actual execution behavior rather than static design configurations, thereby enabling precise dependency tracking and impact analysis in regulated environments.

Another object of the invention is to integrate lineage capture directly within the processing fabric or structural architecture of the pipeline infrastructure, rather than relying solely on external monitoring or cataloging tools. By embedding interception and recording mechanisms at the transformation interface level, the invention aims to ensure completeness and accuracy of captured events regardless of pipeline complexity, dynamic scaling behavior, or distributed execution topology.

A further object of the invention is to provide temporal coherence and ordered sequencing of transformation events across distributed nodes. The invention seeks to implement secure and monotonic timestamping mechanisms that maintain consistent chronological ordering even in geographically distributed or elastically scaled environments, thereby preventing ambiguities in reconstruction and ensuring reliable audit trails.

Another object of the invention is to enhance regulatory compliance by enabling rapid generation of verifiable audit reports derived from immutable lineage records. The invention aims to reduce manual effort required for audit preparation by providing structured, queryable, and replayable lineage data that directly supports evidentiary requirements imposed by regulatory authorities.

An additional object of the invention is to incorporate anomaly detection within the lineage capture pathway to identify structural inconsistencies, unexpected transformation sequences, or unauthorized configuration changes. By analyzing lineage graph patterns in real time, the system aims to detect deviations from expected processing behavior and to preserve enhanced contextual snapshots for subsequent forensic analysis.

Another object of the invention is to ensure secure access control over lineage records and replay functions, thereby restricting reconstruction capabilities to authorized auditors or regulatory personnel. The invention seeks to record replay activities themselves as part of the lineage chain, creating a secondary audit layer that documents interactions with historical records and ensures accountability for investigative actions.

A further object of the invention is to provide scalability and adaptability across heterogeneous computing environments, including on-premises infrastructures, cloud-native deployments, hybrid systems, and edge computing nodes. The invention is intended to maintain consistent lineage integrity and replay capability regardless of underlying infrastructure variations or workload distribution patterns.

Another object of the invention is to minimize performance overhead on operational data pipelines while maintaining continuous lineage capture. The invention aims to achieve efficient interception, compression, and storage of lineage frames through optimized processing modules and hardware-accelerated cryptographic functions, thereby ensuring that compliance assurance does not compromise operational throughput.

An additional object of the invention is to facilitate long-term preservation of lineage data in a storage-efficient yet immutable format suitable for extended regulatory retention periods. The invention seeks to structure lineage blocks in append-only formats with cryptographic linkage, ensuring durability, compression efficiency, and verifiable integrity across extended archival horizons.

It is also an object of the invention to provide a unified structural solution that integrates transformation interception, cryptographic anchoring, temporal synchronization, semantic encoding, graph construction, and deterministic replay within a coordinated machine architecture. By consolidating these functions into a cohesive system, the invention aims to overcome fragmentation inherent in prior art solutions and to deliver a comprehensive framework for regulated data governance.

Through the foregoing objectives, the invention seeks to advance the technical field of regulated data pipeline management by delivering a robust, secure, reproducible, and audit-grade lineage capture and replay system capable of meeting the stringent demands of modern compliance environments.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for continuous data lineage capture and deterministic replay in regulated data pipelines; and

FIG. 2 displays flow chart of a method for a computer-implemented method for continuous data lineage capture and deterministic replay in regulated data pipelines.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

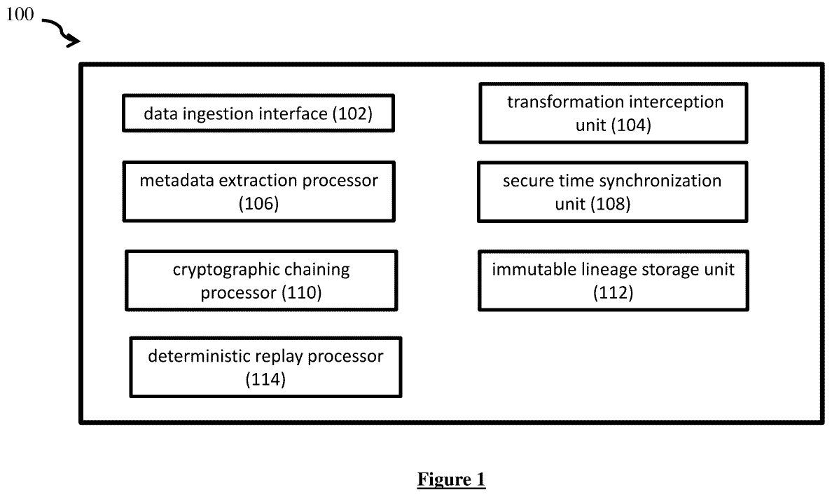

Referring to FIG. 1, a block diagram of a system for continuous data lineage capture and deterministic replay in regulated data pipelines is illustrated. The system 100 comprising: a data ingestion interface (102) configured to receive structured and unstructured data streams from one or more upstream data sources; a transformation interception unit (104) electrically and logically coupled between a pipeline execution environment and at least one data storage resource, the transformation interception unit being configured to monitor and intercept data transformation operations executed within the pipeline execution environment; a metadata extraction processor (106) operatively coupled to the transformation interception unit, the metadata extraction processor being configured to generate lineage event records comprising transformation identifiers, input dataset identifiers, output dataset identifiers, execution parameter values, schema state descriptors, and access authorization context information associated with each intercepted data transformation operation; a secure time synchronization unit (108) comprising a hardware-based clock source and a monotonic time validation circuit configured to assign cryptographically verifiable timestamps to each lineage event record; a cryptographic chaining processor (110) configured to compute a sequential hash value for each lineage event record and to generate a chained integrity value derived from a preceding lineage event record, thereby forming a tamper-evident ordered lineage sequence; an immutable lineage storage unit (112) configured as an append-only persistent storage structure for storing chained lineage event records in chronological order; and a deterministic replay processor (114) configured to retrieve selected lineage event records from the immutable lineage storage unit and to reconstruct, within an isolated execution environment, a historical data processing state corresponding to the retrieved lineage event records in order to reproduce at least one historical output dataset.

In an embodiment, the transformation interception unit (104) comprises a programmable logic circuit arranged on a dedicated processing board and configured to intercept execution-level instructions corresponding to data transformation operators, including filtering operations, aggregation operations, join operations, enrichment operations, and user-defined transformation logic, and wherein the programmable logic circuit generates a transformation descriptor containing operator version identifiers, execution configuration parameters, and runtime dependency references for inclusion within each lineage event record.

In an embodiment, the metadata extraction processor (106) is further configured to capture environmental state descriptors including software library version identifiers, container image identifiers, hardware resource allocation descriptors, and configuration file checksum values, and to associate the environmental state descriptors with the corresponding lineage event record to enable exact reconstruction of execution context during replay.

In an embodiment, the secure time synchronization unit (108) comprises a trusted time source interface and a hardware validation circuit configured to prevent backward adjustment of system time, and wherein each lineage event record includes a time attestation signature generated using a protected cryptographic key stored within a tamper-resistant secure element integrated into the system.

In an embodiment, the cryptographic chaining processor (110) is configured to compute, for each lineage event record, a first hash value over the contents of the lineage event record and a second hash value derived from a concatenation of the first hash value and a preceding chained integrity value, and to store the second hash value as part of the lineage event record to ensure sequential immutability of the lineage sequence.

In an embodiment, the immutable lineage storage unit (112) comprises a segmented storage matrix organized into fixed-size lineage blocks, each lineage block containing a plurality of lineage event records and a block-level integrity hash computed over all lineage event records contained therein, and wherein each lineage block further includes a reference to a preceding lineage block to form a continuous integrity chain across the segmented storage matrix.

In an embodiment, further comprising a lineage graph construction processor configured to transform stored lineage event records into a directed dependency graph representation in which nodes represent datasets, transformation operations, policy evaluations, and authorized actors, and edges represent data flow relationships and authorization relationships, wherein the directed dependency graph is incrementally updated in response to newly stored lineage event records.

In an embodiment, the lineage graph construction processor is further configured to store versioned snapshots of the directed dependency graph at predetermined intervals and to associate each snapshot with a corresponding block identifier within the immutable lineage storage unit to enable efficient retrieval of graph states corresponding to specific historical time ranges.

In an embodiment, the deterministic replay processor (114) comprises an isolated execution container configured to replicate a historical runtime environment by loading recorded software library versions, configuration parameters, schema definitions, and input dataset hash references stored within selected lineage event records, and wherein the deterministic replay processor is further configured to execute transformation operations in a sequence strictly ordered according to the timestamps and dependency relationships recorded in the lineage event records.

In an embodiment, the deterministic replay processor (114) is further configured to compute verification hash values for output datasets generated during replay and to compare the verification hash values with stored output dataset hash values contained in corresponding lineage event records, and to generate a discrepancy record within the immutable lineage storage unit if a mismatch is detected.

In an embodiment, the transformation interception unit further comprises an execution-layer instrumentation module embedded within the pipeline execution environment and configured to register pre-execution and post-execution hooks around each data transformation operator invocation, said instrumentation module being arranged to capture a serialized representation of input dataset states prior to execution and a serialized representation of output dataset states immediately after execution, and to compute a structural delta descriptor representing field-level additions, deletions, reordering, and datatype coercion events occurring during the transformation, and wherein the metadata extraction processor is configured to embed said structural delta descriptor within the corresponding lineage event record in association with a transformation execution sequence identifier generated for each intercepted operation, such that replay reconstruction is performed using both the transformation descriptor and the structural delta descriptor to reproduce schema evolution in a deterministic manner.

In this embodiment, the execution-layer instrumentation module is deployed within the internal execution engine of the pipeline framework at the operator dispatch and task scheduling layer, such that it operates transparently to user-defined transformation logic while having direct access to in-memory dataset representations. When a transformation operator is scheduled for execution, the module first activates a pre-execution hook that interfaces with the pipeline's logical plan representation and its corresponding physical execution plan. At this stage, the module extracts the complete input dataset state by traversing the in-memory schema objects, partition descriptors, column metadata structures, and encoding definitions, and converts them into a canonical serialized representation. This canonicalization process eliminates non-deterministic ordering artifacts by sorting schema elements, normalizing metadata attributes, resolving alias mappings to fully qualified identifiers, and encoding datatype descriptors in a stable structural format. In addition to schema structure, the module records dataset-level characteristics such as partitioning keys, clustering rules, nullability constraints, and implicit casting policies active within the execution engine at that moment.

Immediately after the operator completes execution, the post-execution hook performs an equivalent traversal of the resulting dataset's schema and structural metadata, again generating a canonical serialized representation using the same deterministic ordering rules. A structural comparison engine within the instrumentation module then constructs abstract structural trees of both pre-execution and post-execution schema representations and performs node-by-node comparison to identify modifications. The resulting structural delta descriptor captures granular evolution events, including addition of derived columns, deletion of intermediate fields, reordering of attributes within composite structures, expansion or contraction of nested data types, precision changes in numeric fields, implicit or explicit datatype coercion rules applied during transformation, and renaming operations resolved through alias substitution tables. Where datatype coercion occurs, the descriptor records both the source datatype, the target datatype, and the transformation rule applied by the execution engine, including rounding modes or format normalization logic when applicable.

For example, if a transformation stage processes a dataset containing a string-based date field and converts it into a standardized timestamp format while also introducing a computed aggregation column derived from grouped records, the instrumentation module records the exact structural mapping from the original string datatype to the timestamp datatype, the parsing pattern used by the engine, and the insertion order of the derived column within the schema hierarchy. If nested JSON structures are flattened into relational columns, the descriptor records the hierarchical extraction path and positional reallocation of the flattened fields. Because the canonical serialization captures both structural metadata and contextual execution parameters, even subtle schema evolution caused by engine version changes or implicit casting behavior is preserved.

The metadata extraction processor associates each computed structural delta descriptor with a transformation execution sequence identifier that reflects the precise ordering of operator invocation within the pipeline's directed execution graph. This identifier is generated through a monotonic counter synchronized with the interception layer to ensure that parallel operator executions are serialized into a deterministic lineage order. The structural delta descriptor, together with the transformation descriptor and environmental state information, is embedded within the corresponding lineage event record before cryptographic chaining and storage.

During deterministic replay, the replay processor reconstructs the historical schema state by first restoring the serialized pre-execution schema representation and then applying the stored transformation descriptor in combination with the recorded structural delta descriptor. Rather than relying solely on re-executing transformation code to infer schema changes, the replay processor explicitly applies the delta operations in the exact sequence recorded, ensuring that field ordering, datatype promotion rules, and nested structure handling replicate the original execution behavior. This prevents divergence that might otherwise arise from engine upgrades, configuration drift, or implicit casting rule modifications. The result is that complex schema evolution scenarios—such as multi-stage enrichment pipelines with nested transformations and incremental column derivations—are reproduced with structural fidelity across time, enabling accurate audit reconstruction and validation of historical outputs even under changed runtime conditions.

In an embodiment, the programmable logic circuit of the transformation interception unit further comprises an instruction fingerprinting sub-module configured to compute an execution fingerprint derived from a normalized representation of transformation bytecode, operator configuration parameters, and referenced dependency libraries, said execution fingerprint being generated prior to execution and stored within the lineage event record, and wherein the deterministic replay processor is configured, during reconstruction, to validate the execution fingerprint against a locally computed fingerprint of the replayed transformation instruction set before permitting execution, and to suspend replay in response to a mismatch between the stored and locally computed execution fingerprints.

In this embodiment, the programmable logic circuit positioned within the transformation interception unit operates at a layer beneath the user-accessible execution APIs and directly interfaces with the compiled representation of each transformation operator prior to its dispatch to the execution engine. When a transformation is submitted for execution, the instruction fingerprinting sub-module retrieves the intermediate bytecode or compiled operator representation generated by the pipeline framework's compiler or query planner. This representation is first subjected to a normalization procedure implemented in hardware logic, wherein non-deterministic elements such as memory allocation addresses, transient session identifiers, thread-specific offsets, and compiler-generated symbol table references are stripped or replaced with canonical placeholders. The normalized bytecode is then serialized in a deterministic ordering sequence that ensures identical logical instructions yield identical canonical encodings irrespective of runtime memory layout.

In parallel, the sub-module extracts operator configuration parameters including execution flags, optimizer hints, join strategies, partitioning directives, resource allocation directives, and any runtime toggles influencing execution semantics. These parameters are serialized in sorted key-value order to eliminate variability in configuration ordering. Additionally, all referenced dependency libraries, including user-defined functions, transformation plugins, and supporting runtime modules, are identified through dependency resolution tables within the execution environment. Instead of embedding entire binaries, the system computes cryptographic digests of each dependency binary along with its version identifier and compile-time metadata, thereby generating a stable representation of the executable environment without excessive storage overhead.

The normalized bytecode representation, ordered configuration parameter serialization, and dependency digests are concatenated in a predefined deterministic sequence within the programmable logic circuit. This composite data structure is then processed through a collision-resistant hashing function implemented directly in hardware to prevent interference by software-level processes. Because the fingerprint computation is executed on a dedicated processing board with restricted firmware access, it cannot be altered or bypassed by pipeline-level instructions. The resulting execution fingerprint uniquely characterizes the exact operational logic and environment context under which the transformation is intended to run. This fingerprint is embedded within the corresponding lineage event record prior to transformation execution and cryptographic chaining.

For example, if a transformation performs a grouped aggregation using a specific optimizer hint that enforces hash-based partitioning and relies on a particular version of a user-defined aggregation library compiled with defined floating-point precision rules, the normalized fingerprint will capture the canonical bytecode of the aggregation operator, the precise configuration flags controlling partitioning behavior, and the digest of the dependency library implementing the aggregation logic. Even a minor modification, such as a patch-level change to the dependency library altering internal loop unrolling or arithmetic precision, results in a different digest and therefore a different execution fingerprint.

During deterministic replay, the replay processor reconstructs the transformation environment within an isolated execution container and regenerates the normalized bytecode and configuration serialization using the same canonicalization procedure embedded in the programmable logic circuit. It then computes a local execution fingerprint over the reconstructed transformation instruction set. This locally computed fingerprint is compared with the stored fingerprint extracted from the lineage event record. If the fingerprints match exactly, replay execution proceeds. If a discrepancy is detected, the replay processor suspends execution and generates a verification exception, thereby preventing reproduction under altered executable conditions.

This mechanism eliminates silent behavioral divergence caused by environmental drift, unintended library upgrades, configuration changes, or compiler modifications. It ensures that historical transformation outputs can only be regenerated when the executable logic and its dependency context are bitwise equivalent to the originally recorded state. By binding transformation logic identity directly into the lineage record through hardware-assisted fingerprint computation, the system provides a deterministic enforcement layer that preserves computational integrity across temporal and infrastructural changes, enabling reliable regulatory audit reconstruction and reproducibility of complex data processing workflows.

In an embodiment, the secure time synchronization unit further comprises a distributed time attestation interface configured to periodically reconcile the hardware-based clock source with at least one external trusted time authority through a signed time beacon exchange protocol, and wherein the monotonic time validation circuit is configured to record a time drift vector representing deviation between the hardware-based clock source and the trusted time authority, and to append said time drift vector to each lineage event record generated within a reconciliation interval, such that deterministic replay incorporates recorded temporal offsets to reproduce time-dependent transformation behaviors executed under the original temporal conditions.

In this embodiment, the secure time synchronization unit operates as an independent hardware-governed timing subsystem that is logically isolated from the general-purpose system clock used by the operating system. The distributed time attestation interface periodically initiates a reconciliation cycle by generating a cryptographically random nonce within the secure hardware boundary and transmitting the nonce to an external trusted time authority over an authenticated communication channel. The trusted time authority returns a digitally signed time beacon containing a precise timestamp and the original nonce. The secure time synchronization unit verifies the authenticity of the beacon by validating the digital signature using a stored public verification key embedded in protected memory and confirms freshness by matching the returned nonce with the transmitted nonce.

Once verified, the hardware-based clock source is compared with the trusted timestamp to compute a deviation metric. This deviation is not limited to a simple offset value but is encoded as a time drift vector that includes absolute offset, measured round-trip latency, jitter characteristics observed during the exchange, and a confidence coefficient derived from network stability metrics. The monotonic time validation circuit maintains an increment-only counter that advances strictly forward and overrides any backward adjustments attempted at the operating system level. If the hardware clock lags behind the trusted time, corrective adjustment is applied gradually using a bounded forward correction technique that preserves monotonic continuity. If the hardware clock leads the trusted authority, the circuit refrains from rolling the clock backward and instead records the magnitude of the forward skew within the drift vector.

Each lineage event record generated during the interval between two reconciliation cycles is appended with the most recently computed drift vector, along with an identifier referencing the corresponding reconciliation session. This ensures that every recorded transformation event contains contextual timing information reflecting the exact temporal deviation present during its execution. For example, in a streaming pipeline performing event-time window aggregations based on watermark thresholds, even a few milliseconds of clock skew can influence which records are included in a given window. By storing the drift vector alongside the lineage record, the system preserves the precise temporal offset under which window boundaries were evaluated. During deterministic replay, the replay processor reads the stored drift vector and applies the recorded offset and jitter compensation parameters to its local timing subsystem before executing time-dependent logic. This allows replay to reconstruct the same event ordering, watermark evaluation decisions, and timeout behaviors that occurred during original execution.

The monotonic validation circuit also records reconciliation interval identifiers and maintains a continuity log ensuring that no temporal gaps or overlaps exist between successive intervals. If a reconciliation attempt fails or yields anomalous latency, the circuit flags the interval and embeds the anomaly indicator within subsequent lineage event records. This ensures that any period of temporal instability is explicitly documented and can be considered during replay or forensic analysis. By binding each transformation event to a verified and context-aware timing state, the system preserves chronological integrity across distributed infrastructure, prevents manipulation of execution timestamps, and enables faithful reconstruction of time-sensitive processing semantics even when replayed under different hardware or network conditions.

In an embodiment, the immutable lineage storage unit further comprises a write-ahead lineage buffer configured to temporarily stage newly generated lineage event records in volatile memory, and a commit controller configured to aggregate staged lineage event records into a lineage block only after verification of sequential chained integrity values and time attestation signatures, and wherein the commit controller is further configured to atomically persist the lineage block and its associated block-level integrity hash within the segmented storage matrix using a transactional write protocol that prevents partial block persistence in the event of interruption, thereby preserving ordered continuity of the chained lineage sequence.

In this embodiment, the immutable lineage storage unit incorporates a memory-resident write-ahead lineage buffer that operates as an intermediate staging layer between the lineage generation components and the persistent segmented storage matrix. Each newly generated lineage event record is first written into this volatile buffer in strict sequence order based on its transformation execution sequence identifier and chained integrity reference. The buffer maintains an in-memory index table that tracks record ordering, predecessor hash linkage, timestamp attestation validity, and key epoch reference, thereby enabling immediate validation before any persistence attempt.

Upon insertion of a lineage event record into the write-ahead buffer, the commit controller initiates a validation routine that recalculates the chained integrity value using the immediately preceding record already verified in the buffer or in persistent storage. It also verifies the time attestation signature embedded within the record by invoking the secure element verification interface. Only when both the chained hash linkage and time attestation signature are confirmed as valid does the record remain eligible for block aggregation. If any validation step fails, the record is quarantined within a separate diagnostic memory region without disrupting the ordered buffer sequence, thereby preventing contamination of the immutable chain.

The commit controller continuously monitors the buffer for a threshold condition, such as a predetermined count of validated records or a time-based aggregation trigger, and upon reaching such condition, it initiates formation of a lineage block. During block formation, the controller arranges the staged records in deterministic order and computes a block-level integrity hash by iteratively hashing the concatenated serialized representations of each lineage event record within the block. This block-level hash is derived using the same cryptographic standard applied for individual chained integrity values, ensuring hierarchical consistency between record-level and block-level verification layers.

To ensure atomic persistence, the commit controller employs a transactional write protocol consisting of a multi-phase commit sequence. In a first phase, the lineage block payload is written to a designated storage segment in the segmented storage matrix, but marked as provisional through a metadata flag. In a second phase, the computed block-level integrity hash and a reference pointer to the immediately preceding lineage block are written to a separate integrity index sector. In the final phase, a commit confirmation marker is written that references both the block payload location and the integrity index entry. Only upon successful completion of all phases is the provisional flag cleared, marking the lineage block as permanently committed.

If a system interruption such as power loss or hardware fault occurs during any phase of this sequence, the recovery logic executed upon system restart scans the segmented storage matrix for provisional blocks lacking a corresponding commit confirmation marker. Any such incomplete block is invalidated and removed from the active index without affecting previously committed blocks. Because the write-ahead buffer retains only validated records and does not release them until successful commit confirmation, interrupted transactions do not break the chained integrity sequence or introduce orphaned records.

For example, if multiple transformation operations generate lineage records in rapid succession during high-throughput processing, the buffer ensures ordered staging and validation before persistence. Should a failure occur during block persistence, the recovery mechanism guarantees that only fully validated and atomically committed blocks become part of the immutable sequence. This layered validation and transactional persistence architecture maintains strict chronological continuity, prevents partial or out-of-order block insertion, and preserves verifiable immutability across the entire lineage chain even under adverse operating conditions.

In an embodiment, the lineage graph construction processor further comprises a dependency resolution engine configured to parse transformation identifiers and input-output dataset identifiers contained within the lineage event records to construct adjacency mappings, and to compute transitive dependency paths representing indirect data derivations across multiple transformation stages, and wherein said dependency resolution engine incrementally updates node-level provenance attributes including cumulative transformation depth, upstream policy inheritance flags, and actor access lineage vectors, and stores said node-level provenance attributes within an indexed graph state repository associated with the immutable lineage storage unit to facilitate selective replay of only those transformation branches affecting a specified output dataset.

In this embodiment, the lineage graph construction processor continuously monitors newly committed lineage event records and invokes the dependency resolution engine immediately after block-level validation has been completed. The engine parses each lineage event record by extracting transformation identifiers, input dataset identifiers, output dataset identifiers, execution sequence identifiers, and associated authorization context descriptors. These elements are converted into structured graph primitives in which each dataset and transformation is represented as a uniquely indexed node and each data flow relationship is represented as a directed edge from input dataset nodes to transformation nodes and from transformation nodes to output dataset nodes. The adjacency mappings are stored in a dynamically maintained graph structure implemented using indexed adjacency lists and hash-based node lookup tables to ensure constant-time resolution of node references even in large-scale pipelines.

When a new transformation is recorded, the dependency resolution engine does not recompute the entire graph from scratch but incrementally updates the graph state by traversing upstream edges originating from the input dataset nodes referenced in the new lineage event record. Through recursive traversal, the engine computes transitive dependency paths that capture indirect derivations spanning multiple transformation stages. For example, if an output dataset is derived from an aggregation applied to an enriched dataset that itself originated from multiple raw ingestion streams, the engine identifies all upstream source datasets and records the complete dependency chain linking them to the final output. During this traversal, the engine calculates cumulative transformation depth values by incrementing depth counters along each path, thereby quantifying how many transformation layers separate a dataset from its original source. This depth metric is stored as a provenance attribute within the corresponding dataset node.

In addition to structural dependency tracking, the engine evaluates policy inheritance semantics by analyzing authorization context information embedded in lineage event records. When a transformation inherits access restrictions from upstream datasets, the engine propagates policy inheritance flags through downstream nodes, recording whether a dataset is subject to composite policy constraints originating from multiple sources. Actor access lineage vectors are also updated by aggregating identifiers of authorized actors involved in upstream transformations. These vectors are maintained as compressed bitmaps or indexed reference arrays to efficiently represent cumulative access history across complex pipelines.

All computed node-level provenance attributes, including transformation depth, policy inheritance indicators, and actor access lineage vectors, are persisted within an indexed graph state repository that is logically coupled with the immutable lineage storage unit. The repository maintains versioned graph snapshots synchronized with lineage block identifiers, enabling the system to reconstruct the precise graph state corresponding to any historical interval. Indexing structures within the repository allow rapid resolution of dependency queries based on dataset identifiers or transformation identifiers without scanning the entire lineage history.

When selective replay is requested for a specified output dataset, the deterministic replay processor queries the graph state repository to retrieve only those nodes and edges that form part of the transitive closure leading to the selected dataset. By identifying the minimal subgraph necessary for reproduction, the system isolates the exact transformation branches that influenced the output while excluding unrelated pipeline segments. For instance, in a scenario where a reporting dataset is generated from one branch of a multi-branch pipeline, the engine ensures that only the relevant upstream ingestion streams and transformation stages are reconstructed during replay. This targeted reconstruction reduces computational overhead and avoids unnecessary reprocessing while preserving completeness of derivation history.

Through incremental graph maintenance, provenance attribute propagation, and indexed state storage, the dependency resolution engine enables precise identification of indirect data derivations and context inheritance relationships. The resulting capability to isolate and replay only the transformations that materially contributed to a given output enhances reproducibility efficiency, ensures accurate historical reconstruction, and maintains consistent interpretation of policy and access constraints across complex and evolving data pipelines.

In an embodiment, the deterministic replay processor further comprises an execution state virtualization controller configured to allocate isolated compute, memory, and storage resources corresponding to hardware resource allocation descriptors captured within the environmental state descriptors of the lineage event records, and to instantiate a containerized runtime image reconstructed from recorded container image identifiers and configuration file checksum values, and wherein the deterministic replay processor sequentially restores intermediate dataset states by resolving input dataset hash references to immutable dataset snapshots stored in association with the lineage event records prior to executing each transformation operation in accordance with recorded dependency relationships.

In this embodiment, the deterministic replay processor operates under the control of an execution state virtualization controller that reconstructs the historical runtime environment at both the infrastructure and application layers before any transformation logic is executed. When a replay request is initiated for a selected set of lineage event records, the controller first parses the environmental state descriptors embedded within those records to extract hardware resource allocation descriptors, including processor core allocation topology, memory limits, thread concurrency parameters, storage I/O bandwidth constraints, and any recorded accelerator usage indicators. These descriptors are not merely advisory; they are translated into enforceable isolation policies using a virtualization interface that provisions a dedicated execution sandbox with identical or emulated resource constraints. The controller configures CPU affinity mappings to mirror original scheduling behavior, enforces memory ceilings through cgroup-style isolation mechanisms, and configures storage access layers with the same block size and buffering strategies recorded during original execution.

Once the resource layer has been provisioned, the controller reconstructs the software execution environment by retrieving the recorded container image identifiers from the lineage event records. The integrity of the container image is verified by computing a checksum over the retrieved image layers and comparing it to the stored configuration file checksum values associated with the original execution. If the image is unavailable in its original binary form, the controller reconstructs it by assembling version-specific software packages and configuration artifacts whose checksums match those recorded in the lineage metadata. Configuration files governing environment variables, optimizer parameters, serialization formats, locale settings, and encoding schemes are restored from archived versions, and their integrity is validated against stored checksum values prior to container instantiation. Only after successful verification does the controller launch the containerized runtime instance within the isolated resource sandbox.

Following environment instantiation, the replay processor proceeds to reconstruct intermediate dataset states in strict accordance with the dependency relationships encoded in the lineage graph. For each transformation to be replayed, the processor resolves input dataset hash references recorded in the corresponding lineage event record. These hash references are mapped to immutable dataset snapshots that were archived at the time of original execution. Each snapshot is retrieved from persistent storage and its integrity is verified by recomputing its cryptographic hash and comparing it to the stored reference value. If the hash matches, the dataset snapshot is mounted within the replay container as a read-only input source to prevent accidental mutation.

The replay processor then executes the transformation operation inside the containerized environment using the restored configuration and resource constraints. After execution, the resulting intermediate dataset is serialized using the same canonical encoding format applied during original capture, and its hash is computed for verification against the stored output dataset hash. This sequential restoration and execution process continues along the dependency chain, ensuring that each transformation receives precisely the same input state and operates under equivalent environmental and infrastructural conditions as originally recorded.

For example, if a historical transformation pipeline executed under constrained memory conditions with a specific file system buffering configuration that influenced join execution strategy, the virtualization controller reproduces those constraints during replay. This prevents divergence that might otherwise occur if the replay were executed under expanded resources leading to different optimization paths. By tightly coupling resource-level virtualization, container integrity validation, and immutable dataset snapshot restoration, the system ensures that replay execution faithfully mirrors the original computational context, thereby enabling accurate reproduction of historical outputs across time and infrastructure changes.

In an embodiment, the deterministic replay processor further comprises an intermediate state verification module configured to compute incremental verification hash values after execution of each replayed transformation operation and to compare said incremental verification hash values with corresponding intermediate output dataset hash values stored in the immutable lineage storage unit, and wherein upon detection of a mismatch the intermediate state verification module generates a divergence descriptor identifying the transformation execution sequence identifier, the mismatched dataset identifier, and a computed structural delta between expected and actual outputs, and appends said divergence descriptor as a new lineage event record to the immutable lineage storage unit while preserving the original chained integrity sequence.

In this embodiment, the intermediate state verification module is integrated directly into the execution loop of the deterministic replay processor so that validation occurs immediately after each individual transformation stage is completed rather than only at the final output stage. Once a replayed transformation operation produces its intermediate output dataset within the isolated execution environment, the module initiates a canonical serialization process identical to that used during original lineage capture. This serialization normalizes record ordering, column sequencing, encoding formats, and metadata attributes to eliminate non-deterministic variations such as partition ordering or parallel execution effects. The serialized representation is then processed through the same cryptographic hashing routine originally used to compute the stored output dataset hash, thereby generating an incremental verification hash value corresponding to that specific transformation execution sequence identifier.

The module retrieves the expected intermediate output dataset hash value from the immutable lineage storage unit by referencing the transformation execution sequence identifier and dataset identifier recorded in the lineage event record. A strict equality comparison is performed between the locally computed incremental verification hash and the stored hash value. Because both values are derived from canonicalized representations, even subtle differences in schema structure, record counts, data ordering rules, null handling semantics, or datatype precision will produce a mismatch.

If the verification hashes match, the replay processor proceeds to the next transformation stage in accordance with the dependency relationships encoded in the lineage graph. If a mismatch is detected, the intermediate state verification module transitions into divergence analysis mode. In this mode, it computes a structural delta between the expected dataset state—reconstructed from archived metadata and schema descriptors—and the actual replay-generated dataset. This delta analysis operates at multiple levels, including schema comparison, field-level datatype inspection, row count validation, and statistical distribution comparison for numeric and categorical fields. The computed divergence descriptor records the specific transformation execution sequence identifier at which deviation occurred, the dataset identifier involved, and a detailed summary of structural and content-level discrepancies, such as column addition or omission, datatype coercion differences, aggregation value deviations, or ordering inconsistencies.

Rather than modifying or overwriting any existing lineage event records, the system preserves the integrity of the original chained sequence by creating a new lineage event record representing the divergence descriptor. This new record is cryptographically chained to the latest valid block in the immutable lineage storage unit using the same sequential hashing mechanism, thereby extending the chain without altering prior entries. The appended divergence record includes references to both the expected and actual verification hash values, enabling auditors or automated diagnostic routines to trace the origin of deviation without compromising historical authenticity.

For example, if a replayed aggregation operation yields slightly different floating-point results due to changes in hardware-level arithmetic implementation or compiler optimizations, the incremental verification module detects the discrepancy at the precise transformation stage where it arises. The divergence descriptor captures the variance in computed values along with associated schema or execution context information, allowing targeted forensic analysis. By validating intermediate states rather than solely end results, the system isolates divergence points with fine granularity, strengthens reproducibility assurance, and maintains an auditable extension of the lineage chain that transparently documents any deviation encountered during replay execution.

In an embodiment, further comprising a policy enforcement correlation processor operatively coupled to the metadata extraction processor and configured to intercept and record authorization context information including role identifiers, access control policy versions, and credential validation results active at the time of transformation execution, and to generate a policy evaluation trace descriptor representing rule evaluation paths and decision outcomes associated with each transformation operation, and wherein the deterministic replay processor is configured to reconstruct the historical authorization environment by loading recorded role definitions and policy versions and re-executing the recorded rule evaluation paths prior to executing corresponding transformation operations to ensure that replayed operations are executed under conditions replicating the original authorization context.

In this embodiment, the intermediate state verification module is integrated directly into the execution loop of the deterministic replay processor so that validation occurs immediately after each individual transformation stage is completed rather than only at the final output stage. Once a replayed transformation operation produces its intermediate output dataset within the isolated execution environment, the module initiates a canonical serialization process identical to that used during original lineage capture. This serialization normalizes record ordering, column sequencing, encoding formats, and metadata attributes to eliminate non-deterministic variations such as partition ordering or parallel execution effects. The serialized representation is then processed through the same cryptographic hashing routine originally used to compute the stored output dataset hash, thereby generating an incremental verification hash value corresponding to that specific transformation execution sequence identifier.

The module retrieves the expected intermediate output dataset hash value from the immutable lineage storage unit by referencing the transformation execution sequence identifier and dataset identifier recorded in the lineage event record. A strict equality comparison is performed between the locally computed incremental verification hash and the stored hash value. Because both values are derived from canonicalized representations, even subtle differences in schema structure, record counts, data ordering rules, null handling semantics, or datatype precision will produce a mismatch.

If the verification hashes match, the replay processor proceeds to the next transformation stage in accordance with the dependency relationships encoded in the lineage graph. If a mismatch is detected, the intermediate state verification module transitions into divergence analysis mode. In this mode, it computes a structural delta between the expected dataset state—reconstructed from archived metadata and schema descriptors—and the actual replay-generated dataset. This delta analysis operates at multiple levels, including schema comparison, field-level datatype inspection, row count validation, and statistical distribution comparison for numeric and categorical fields. The computed divergence descriptor records the specific transformation execution sequence identifier at which deviation occurred, the dataset identifier involved, and a detailed summary of structural and content-level discrepancies, such as column addition or omission, datatype coercion differences, aggregation value deviations, or ordering inconsistencies.

Rather than modifying or overwriting any existing lineage event records, the system preserves the integrity of the original chained sequence by creating a new lineage event record representing the divergence descriptor. This new record is cryptographically chained to the latest valid block in the immutable lineage storage unit using the same sequential hashing mechanism, thereby extending the chain without altering prior entries. The appended divergence record includes references to both the expected and actual verification hash values, enabling auditors or automated diagnostic routines to trace the origin of deviation without compromising historical authenticity.

For example, if a replayed aggregation operation yields slightly different floating-point results due to changes in hardware-level arithmetic implementation or compiler optimizations, the incremental verification module detects the discrepancy at the precise transformation stage where it arises. The divergence descriptor captures the variance in computed values along with associated schema or execution context information, allowing targeted forensic analysis. By validating intermediate states rather than solely end results, the system isolates divergence points with fine granularity, strengthens reproducibility assurance, and maintains an auditable extension of the lineage chain that transparently documents any deviation encountered during replay execution.

In an embodiment, the cryptographic chaining processor further comprises a key rotation management module configured to periodically generate new cryptographic key pairs within the tamper-resistant secure element and to embed a key transition descriptor within a lineage event record at the time of key rotation, said key transition descriptor including a signed reference to a preceding public key and a validity interval indicator, and wherein subsequent chained integrity values are computed using the newly generated cryptographic key pair while preserving verifiable linkage to lineage event records signed under preceding cryptographic keys, such that deterministic replay and integrity verification span multiple key epochs without interruption of the chained lineage sequence.

In this embodiment, the cryptographic chaining processor incorporates a key rotation management module implemented within a tamper-resistant secure element that physically isolates private key material from the host operating environment. The secure element contains a hardware random number generator and a protected key derivation circuit used to generate asymmetric cryptographic key pairs at defined rotation intervals based on policy or elapsed usage thresholds. When a rotation event is triggered, the module generates a new private-public key pair internally and securely seals the private key within the hardware boundary so that it cannot be exported in plaintext form. The corresponding public key is registered within the system's verification registry and prepared for inclusion in the next lineage event record.

At the precise point of key rotation, the module creates a key transition descriptor that is appended as a dedicated lineage event record in sequence with transformation-related records. This descriptor contains the newly generated public key, a signed reference to the immediately preceding public key, and a validity interval indicator specifying the start sequence identifier or timestamp from which the new key becomes active. The signed reference is produced by signing the new public key with the previous private key, thereby forming a cryptographically verifiable linkage between successive key epochs. This cross-signature ensures that trust in the previous key extends to the new key without requiring external re-establishment of trust anchors.

Following the key transition record, all subsequent chained integrity values for lineage event records are computed using the new private key. The chaining logic incorporates both the record payload and the prior chained integrity value, maintaining continuity of the hash-linked sequence while embedding signatures generated under the active key epoch. Because each key transition descriptor includes both forward and backward references through cryptographic signatures, any attempt to insert or remove lineage records across epoch boundaries would invalidate the continuity of signatures and chained hashes.

For example, if the system rotates keys quarterly to comply with security governance requirements, lineage records created during one quarter are signed using the initial key pair, and at the start of the next quarter, a key transition descriptor is recorded linking the old and new keys. When verifying lineage integrity during deterministic replay or audit, the verification engine processes the chained integrity values sequentially, validating each record's signature using the public key active during its recorded validity interval. Upon encountering a key transition descriptor, the engine verifies the cross-signature linking the two key epochs before continuing validation under the new public key. This enables uninterrupted verification of records spanning multiple rotation cycles without requiring manual reconfiguration.

The validity interval indicator ensures that each record can be associated with the correct key epoch during replay validation, preventing ambiguity in signature verification. Additionally, because key generation and storage occur exclusively within the tamper-resistant secure element, exposure of host-level credentials does not compromise historical lineage signatures. By embedding explicit and cryptographically linked key transition descriptors within the immutable lineage chain, the system preserves continuous verifiability across successive key generations, supports long-term archival validation, and maintains uninterrupted integrity assurance even as cryptographic keys evolve over extended operational lifecycles.

Each functional unit described herein is implemented as a tangible hardware component or as firmware executing on dedicated processing circuitry so that the system operates through concrete physical structures rather than abstract logic. The data ingestion interface is realized as a network interface controller and associated input/output circuitry mounted on a system board, including physical transceivers, packet buffers, and direct memory access controllers configured to receive structured and unstructured data streams and write them into system memory. The transformation interception unit is implemented on a dedicated processing board comprising a programmable logic device or reconfigurable hardware fabric interconnected with the main processor bus, the device being configured at the gate level to monitor instruction calls and data movement signals between the pipeline execution environment and storage subsystems. The metadata extraction processor is embodied as a microprocessor or co-processor with allocated volatile and non-volatile memory, executing firmware instructions that parse intercepted execution signals and generate lineage event records in a structured binary format. The secure time synchronization unit comprises a hardware clock oscillator, a monotonic counter circuit, and a cryptographic verification circuit integrated within a secure hardware enclosure that prevents unauthorized modification of time values. The cryptographic chaining processor is implemented as a hardware cryptographic accelerator including arithmetic logic circuitry for hash computation and digital signature generation, optionally integrated with a tamper-resistant secure element that stores private keys in protected non-exportable memory. The immutable lineage storage unit is embodied as a persistent storage array including non-volatile memory devices organized into segmented storage blocks, controlled by a storage controller that enforces append-only write semantics at the firmware level. The write-ahead lineage buffer resides in volatile memory physically attached to the processing subsystem and managed by a memory controller enforcing ordered write sequencing. The commit controller is implemented as firmware executed by a dedicated control processor interfaced with the storage controller to perform transactional multi-phase write operations. The lineage graph construction processor and dependency resolution engine are executed by a processing unit with dedicated memory regions configured to maintain indexed adjacency structures and graph state repositories stored in persistent memory. The deterministic replay processor is implemented as a hardware processing subsystem capable of instantiating isolated execution environments through virtualization extensions supported by the processor architecture, coupled with memory management hardware that enforces resource isolation. The execution state virtualization controller operates through hardware-assisted virtualization circuitry that allocates compute cores, memory partitions, and storage interfaces to replay environments. The intermediate state verification module is realized as a hardware-accelerated hashing engine integrated with the replay processor to compute verification hashes over serialized dataset representations stored in memory. The policy enforcement correlation processor is embodied as a processing unit interfaced with access control hardware modules that evaluate authorization rules using stored policy definitions in non-volatile memory. The key rotation management module resides within a tamper-resistant cryptographic hardware element containing a true random number generator, secure key storage cells, and digital signature circuitry. Collectively, these components are interconnected via system buses and signal pathways on a physical computing platform, ensuring that each described function is performed by identifiable hardware circuitry or firmware-controlled processing units, thereby enabling practical construction and operation of the complete system.

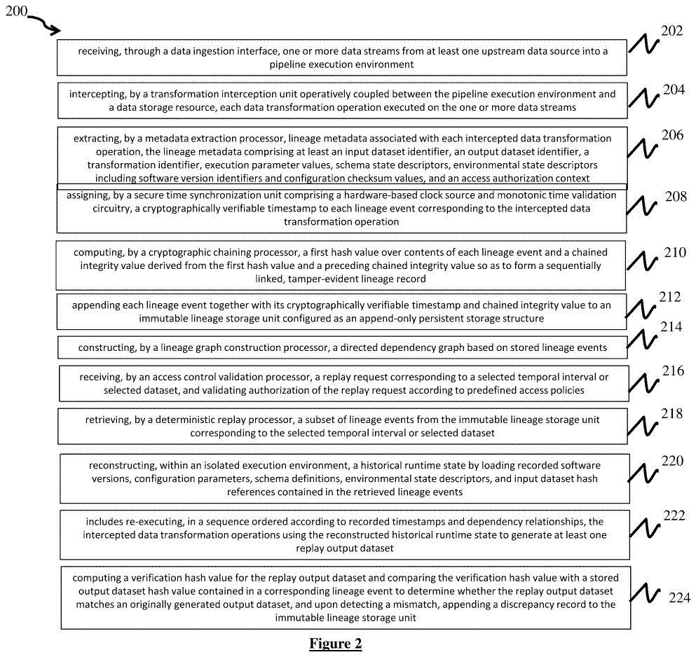

Referring to FIG. 2, a flow chart of a computer-implemented method for continuous data lineage capture and deterministic replay in regulated data pipelines, the method being performed by a computing system comprising at least one processor and at least one non-transitory storage device, the method comprising, the method is illustrated. The method 200 comprising:

At step 202, the method 200 includes receiving, through a data ingestion interface, one or more data streams from at least one upstream data source into a pipeline execution environment;

At step 204, the method 200 includes intercepting, by a transformation interception unit operatively coupled between the pipeline execution environment and a data storage resource, each data transformation operation executed on the one or more data streams, wherein intercepting comprises monitoring execution-level instructions corresponding to transformation operators including filtering, aggregation, joining, enrichment, and user-defined logic;

At step 206, the method 200 includes extracting, by a metadata extraction processor, lineage metadata associated with each intercepted data transformation operation, the lineage metadata comprising at least an input dataset identifier, an output dataset identifier, a transformation identifier, execution parameter values, schema state descriptors, environmental state descriptors including software version identifiers and configuration checksum values, and an access authorization context;

At step 208, the method 200 includes assigning, by a secure time synchronization unit comprising a hardware-based clock source and monotonic time validation circuitry, a cryptographically verifiable timestamp to each lineage event corresponding to the intercepted data transformation operation;

At step 210, the method 200 includes computing, by a cryptographic chaining processor, a first hash value over contents of each lineage event and a chained integrity value derived from the first hash value and a preceding chained integrity value so as to form a sequentially linked, tamper-evident lineage record;

At step 212, the method 200 includes appending each lineage event together with its cryptographically verifiable timestamp and chained integrity value to an immutable lineage storage unit configured as an append-only persistent storage structure;

At step 214, the method 200 includes constructing, by a lineage graph construction processor, a directed dependency graph based on stored lineage events, wherein nodes of the directed dependency graph represent datasets, transformation operations, policy evaluations, and authorized actors, and edges represent data flow relationships and authorization relationships;

At step 216, the method 200 includes receiving, by an access control validation processor, a replay request corresponding to a selected temporal interval or selected dataset, and validating authorization of the replay request according to predefined access policies;

At step 218, the method 200 includes retrieving, by a deterministic replay processor, a subset of lineage events from the immutable lineage storage unit corresponding to the selected temporal interval or selected dataset;

At step 220, the method 200 includes reconstructing, within an isolated execution environment, a historical runtime state by loading recorded software versions, configuration parameters, schema definitions, environmental state descriptors, and input dataset hash references contained in the retrieved lineage events;

At step 222, the method 200 includes re-executing, in a sequence ordered according to recorded timestamps and dependency relationships, the intercepted data transformation operations using the reconstructed historical runtime state to generate at least one replay output dataset; and

At step 224, the method 200 includes computing a verification hash value for the replay output dataset and comparing the verification hash value with a stored output dataset hash value contained in a corresponding lineage event to determine whether the replay output dataset matches an originally generated output dataset, and upon detecting a mismatch, appending a discrepancy record to the immutable lineage storage unit.

In an embodiment, intercepting each data transformation operation further comprises capturing execution-level descriptors generated by a query planner or runtime scheduler, including operator dependency order, memory allocation descriptors, processor allocation identifiers, and intermediate dataset identifiers, and embedding the execution-level descriptors into the lineage metadata associated with the corresponding lineage event to ensure preservation of execution sequencing semantics.

In an embodiment, extracting lineage metadata further comprises computing a checksum value for each input dataset prior to execution of a corresponding data transformation operation and computing a checksum value for each output dataset immediately after completion of the data transformation operation, and storing both checksum values within the lineage event to enable integrity verification during deterministic replay.

In an embodiment, assigning the cryptographically verifiable timestamp further comprises generating a digital signature over the timestamp and at least a portion of the lineage metadata using a cryptographic key stored within a tamper-resistant secure element, and associating the digital signature with the lineage event to prevent retroactive modification of temporal ordering.

In an embodiment, computing the chained integrity value further comprises concatenating a hash of a current lineage event with a chained integrity value of a directly preceding lineage event and generating a new chained integrity value that is stored as part of the current lineage event, thereby forming a continuous cryptographic integrity chain across all stored lineage events.

In an embodiment, appending each lineage event to the immutable lineage storage unit further comprises organizing lineage events into fixed-capacity lineage blocks, computing a block-level integrity hash over all lineage events contained within each lineage block, and storing a reference to a preceding lineage block within each lineage block to extend the cryptographic chain across multiple lineage blocks.

In an embodiment, constructing the directed dependency graph further comprises incrementally updating node and edge relationships upon receipt of each newly appended lineage event, and storing version identifiers of the directed dependency graph corresponding to predefined time intervals to enable retrieval of historical graph states without recomputing the entire dependency structure.

In an embodiment, validating authorization of the replay request further comprises verifying a role attribute of a requesting entity against a predefined regulatory access control policy, generating an authorization decision record indicating approval or denial, and appending the authorization decision record as an additional lineage event within the immutable lineage storage unit.

In an embodiment, reconstructing the historical runtime state further comprises provisioning an isolated execution container configured to replicate a previously recorded hardware resource allocation descriptor and loading software library versions, configuration files, and schema definitions corresponding to those recorded within the retrieved lineage events to ensure environmental consistency.

In an embodiment, re-executing the intercepted data transformation operations further comprises enforcing strict execution ordering based on both timestamp sequencing and dependency relationships represented in the directed dependency graph, such that a transformation operation is executed only after completion of all predecessor operations identified in the directed dependency graph.

The present invention provides a system and corresponding computer-implemented methodology for continuous data lineage capture and deterministic replay in regulated data pipelines, wherein lineage acquisition is performed at execution time and cryptographically secured in an immutable storage structure. The invention operates within a computing environment comprising one or more processors, memory resources, persistent storage devices, and communication interfaces. The system is structurally arranged such that a transformation interception unit is logically interposed between a pipeline execution environment and a data storage resource, thereby ensuring that all transformation operations executed within the pipeline are observable and recordable without reliance on voluntary application-level logging.

During operation, incoming structured or unstructured data streams are received through a data ingestion interface and forwarded to the pipeline execution environment for processing. The transformation interception unit monitors execution-level instructions corresponding to transformation operators including, but not limited to, filtering, projection, aggregation, join, enrichment, sorting, windowing, and user-defined transformation logic. Monitoring is performed by parsing execution descriptors generated by the runtime scheduler or query planner of the pipeline execution environment. The interception logic identifies operator identifiers, operator dependency ordering, input dataset references, output dataset targets, intermediate buffer identifiers, memory allocation descriptors, and processor allocation information. Upon detection of a transformation invocation, the interception unit generates a raw transformation descriptor which is forwarded to a metadata extraction processor.

The metadata extraction processor executes a lineage event generation technique that constructs a structured lineage event record. The technique first assigns a unique transformation event identifier and associates it with input dataset identifiers resolved through storage metadata mapping. For each input dataset, the processor computes a deterministic checksum value using a cryptographic hash function applied over the dataset content or a canonical representation thereof. The processor similarly computes a checksum value for the resulting output dataset immediately upon completion of the transformation. These checksum values serve as immutable fingerprints enabling later verification during replay.

In addition to dataset identifiers and checksum values, the lineage event generation technique extracts execution parameter values including threshold values, configuration settings, query predicates, join conditions, grouping attributes, and runtime tuning parameters. The technique further captures environmental state descriptors comprising software library version identifiers, container image identifiers, configuration file checksum values, hardware resource allocation descriptors, and dependency package versions active during execution. Each of these descriptors is serialized into a canonical format to ensure deterministic hashing and consistent reconstruction.

After assembling the lineage metadata, the system invokes a secure time synchronization unit to assign a cryptographically verifiable timestamp. The timestamp is derived from a hardware-based clock source incorporating monotonic validation circuitry to prevent backward time adjustments. A time attestation signature is generated by signing the timestamp and selected portions of the lineage metadata using a cryptographic key stored within a tamper-resistant secure element integrated into the system. This signature ensures non-repudiation and prevents unauthorized modification of event chronology.

Following timestamp assignment, a cryptographic chaining technique is executed by a cryptographic chaining processor. For each lineage event record, the processor computes a first hash value over the complete serialized contents of the event record. The processor then concatenates this first hash value with a chained integrity value associated with a directly preceding lineage event record. A second hash value is computed over this concatenated data, thereby generating a new chained integrity value for the current lineage event. This process creates a continuous sequential hash chain across all lineage events. The chained integrity value is embedded within the lineage event record before storage.

The immutable lineage storage unit is structured as an append-only persistent storage structure organized into fixed-capacity lineage blocks. When a predefined number of lineage events is accumulated, the system aggregates these events into a lineage block. A block-level integrity hash is computed over the serialized contents of the entire lineage block. Each lineage block contains a reference to a preceding lineage block identifier and its associated block-level integrity hash, thereby extending the cryptographic chain across multiple storage segments. The storage unit enforces write-once semantics through controlled storage interfaces that prevent deletion or modification of previously written records within a predefined retention interval.

Concurrently with storage, a lineage graph construction processor updates a directed dependency graph representation. The graph construction technique maps each lineage event into graph nodes representing datasets, transformation operations, policy evaluation results, and authorized actors. Directed edges are created to represent data flow relationships from input datasets to transformation operations and from transformation operations to output datasets. Additional edges represent authorization relationships linking transformation events with authenticated identities and policy evaluation outcomes. The graph is maintained incrementally; upon arrival of each new lineage event, the processor inserts or updates corresponding nodes and edges while preserving historical versions through graph version identifiers. Periodic snapshots of the graph state are stored and indexed by lineage block identifiers to enable efficient historical retrieval.

When a replay request is received, an access control validation processor verifies the identity and role attributes of the requesting entity against predefined regulatory access policies. Upon authorization, the deterministic replay processor retrieves a subset of lineage events corresponding to a selected temporal interval or dataset. The replay technique reconstructs a historical runtime environment within an isolated execution container. Reconstruction involves loading recorded software library versions, restoring configuration parameters, re-establishing schema definitions, and allocating hardware resources consistent with recorded environmental descriptors.

The replay processor then determines execution order by analyzing both timestamp sequencing and dependency relationships extracted from the directed dependency graph. A topological ordering technique is applied to ensure that each transformation operation is executed only after all predecessor operations have completed. The replay processor re-executes each transformation operation using recorded input datasets or reconstructed intermediate datasets derived from prior replay steps. For each output generated during replay, a verification checksum is computed using the same cryptographic hash function applied during original execution. The verification checksum is compared against the stored output checksum contained in the corresponding lineage event record. If equivalence is established, the transformation is marked as verified. If a discrepancy is detected, a discrepancy report is generated identifying the transformation identifier, execution parameters, or environmental descriptors associated with the mismatch. This discrepancy report is appended as an additional lineage event within the immutable lineage storage unit, thereby preserving a record of replay validation outcomes.

The system further executes an anomaly detection technique operating over the directed dependency graph and lineage event stream. The technique analyzes structural deviations from predefined transformation patterns, detects unauthorized operator identifiers, identifies unexpected parameter changes, and evaluates statistical deviations in transformation frequency. Upon detection of anomalous patterns, an alert record is generated and appended to the immutable lineage storage unit, thereby ensuring that anomaly detection results are themselves subject to cryptographic chaining and retention enforcement.

In distributed deployments comprising multiple computing nodes, each node performs interception, metadata extraction, timestamp assignment, and cryptographic chaining locally. At predefined synchronization intervals, nodes exchange block-level integrity hashes and validate consistency through a consensus validation procedure. The consensus procedure verifies that each node's most recent lineage block references the correct preceding block identifier and integrity hash, thereby ensuring coherence of a global integrity chain across distributed segments of the regulated data pipeline.

The technique design ensures that every data transformation, environmental context, authorization decision, and replay activity is captured, cryptographically secured, temporally ordered, and immutably preserved. By combining execution-level interception, deterministic hashing, chained integrity validation, incremental graph construction, isolated runtime reconstruction, and verification-based replay, the system provides a comprehensive and technically robust solution for verifiable data lineage capture and reproducible processing within regulated computing environments.

The disclosed invention comprises a structurally integrated data lineage capture and replay machine configured as a modular hardware-backed processing structure deployable within regulated computing infrastructures. The machine includes a physical housing structure containing a multi-layer processing board assembly. The assembly comprises a transformation interception bus electrically coupled to one or more data ingestion ports configured for high-throughput streaming interfaces. The ingestion ports are configured to receive structured and unstructured data streams from upstream data sources, including transactional systems, IoT acquisition nodes, enterprise resource planning systems, and external regulatory feeds.

The transformation interception bus is electrically interposed between pipeline execution engines and storage subsystems, thereby enabling real-time capture of data transformation operations at the instruction level or execution operator level. The bus includes programmable logic circuitry capable of parsing execution descriptors, transformation operators, technique identifiers, version hashes, runtime parameters, and access control states. Each transformation event is encapsulated into a lineage event frame comprising source identifier metadata, timestamp metadata generated by a secure temporal coherence controller, transformation operator signature, input-output mapping descriptors, and execution environment fingerprint data.

The secure temporal coherence controller comprises a hardware-based clock synchronization module incorporating cryptographically signed time attestations derived from a trusted time authority. The controller ensures monotonic timestamp assignment and prevents retroactive modification of event sequences. Each lineage event frame is sequentially passed to a cryptographic state anchoring engine. The anchoring engine comprises a hardware-accelerated hashing module configured to compute chained cryptographic digests over ordered lineage frames. The engine further generates digital signatures using a protected key storage module embedded within a secure element, thereby ensuring tamper-evidence and non-repudiation.

The lineage event frames are stored within a secure persistent lineage vault implemented as a distributed append-only data store. The vault structure comprises a segmented storage matrix organized into immutable lineage blocks. Each lineage block contains compressed lineage graphs representing directed acyclic transformation graphs. The blocks are cryptographically linked through hash pointers forming an integrity chain. The vault enforces write-once semantics through hardware-enforced storage controllers and prevents unauthorized deletion or alteration.

The lineage capture process further includes semantic encoding logic configured to extract schema states, transformation semantics, data quality metrics, anomaly detection flags, access authorization states, and policy evaluation outcomes. These elements are encoded into a structured lineage graph representation comprising nodes representing datasets, transformations, policies, and actors, and edges representing data flow dependencies and authorization relationships. The graph is versioned and incrementally updated in real time.

The replay subsystem comprises a deterministic replay processor configured to reconstruct pipeline states using stored lineage graphs and associated execution artifacts. The replay processor retrieves relevant lineage blocks corresponding to a selected temporal interval or regulatory event trigger. It reconstructs the transformation graph in a controlled execution sandbox environment. The sandbox environment includes a controlled runtime replicating the original technique versions, configuration parameters, schema definitions, and environmental dependencies recorded in the lineage frames.

The deterministic replay processor enforces strict ordering constraints derived from timestamp sequences and transformation dependencies. It re-executes transformations using stored input hashes and configuration parameters. During replay, the processor computes verification hashes for generated outputs and compares them with stored output hashes to validate deterministic equivalence. In case of divergence, the system generates a regulatory discrepancy report identifying deviation points within the transformation graph.

The method implemented by the machine comprises continuously intercepting transformation operations within a regulated data pipeline; extracting and encoding metadata including transformation logic identifiers, execution parameters, environmental state descriptors, and policy evaluation outcomes; generating secure timestamps and cryptographic hashes; appending lineage frames into an immutable lineage vault; constructing incremental directed lineage graphs; and enabling deterministic replay of selected pipeline segments for audit verification.

The system further includes an adaptive anomaly detection module integrated within the lineage capture pathway. This module analyzes structural graph deviations, unexpected transformation sequences, or parameter inconsistencies. Upon detection of anomalous lineage patterns, the system generates regulatory alerts and preserves additional contextual lineage snapshots for forensic depth.

Access control to lineage data is enforced through a role-based authorization controller integrated within the machine. The controller validates replay requests against regulatory access policies and ensures that only authorized auditors can initiate reconstruction. All replay activities are themselves recorded as lineage events, thereby creating meta-lineage capturing audit interactions.

The disclosed structure may be deployed as a standalone appliance, an embedded module within enterprise servers, or as a distributed cluster of coordinated lineage machines communicating through secure interconnect links. The distributed configuration maintains global lineage coherence using consensus-synchronized hash anchoring, thereby enabling multi-site regulatory traceability.

The machine further incorporates a hardware isolation partition separating lineage capture logic from application execution domains. This structural separation prevents manipulation of lineage data by application-level processes. The secure element storing cryptographic keys is shielded against extraction through tamper-detection circuitry that triggers zeroization upon unauthorized access attempts.

In operation, the system ensures that every byte entering or exiting a regulated pipeline is associated with a verifiable lineage path. The deterministic replay capability provides regulatory authorities with the ability to reproduce historical outputs exactly as originally generated, thereby satisfying compliance requirements for transparency, accountability, and audit integrity.

The disclosed system and method provide continuous, tamper-evident lineage capture integrated at the processing fabric level rather than relying on superficial logging. The cryptographically chained lineage blocks ensure immutability and non-repudiation. Deterministic replay guarantees reproducibility of regulated outputs. Hardware-based time attestation prevents timestamp manipulation. Structural isolation and secure key storage protect integrity against insider threats. The architecture scales across distributed data pipelines while maintaining global lineage coherence.

The “System and Method for Continuous Data Lineage Capture and Replay in Regulated Data Pipelines” provides a structurally integrated machine and coordinated methodology for ensuring comprehensive data traceability, cryptographic integrity, and deterministic replay within regulated computing environments. By combining transformation interception, hardware-anchored timestamping, cryptographic chaining, immutable storage, semantic graph encoding, and replay verification, the invention enables regulatory-grade auditability and reproducible pipeline execution while preserving operational efficiency and system scalability.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for continuous data lineage capture and deterministic replay in regulated data pipelines, the system comprising:
a data ingestion interface configured to receive structured and unstructured data streams from one or more upstream data sources;
a transformation interception unit electrically and logically coupled between a pipeline execution environment and at least one data storage resource, the transformation interception unit being configured to monitor and intercept data transformation operations executed within the pipeline execution environment;
a metadata extraction processor operatively coupled to the transformation interception unit, the metadata extraction processor being configured to generate lineage event records comprising transformation identifiers, input dataset identifiers, output dataset identifiers, execution parameter values, schema state descriptors, and access authorization context information associated with each intercepted data transformation operation;
a secure time synchronization unit comprising a hardware-based clock source and a monotonic time validation circuit configured to assign cryptographically verifiable timestamps to each lineage event record;
a cryptographic chaining processor configured to compute a sequential hash value for each lineage event record and to generate a chained integrity value derived from a preceding lineage event record, thereby forming a tamper-evident ordered lineage sequence;
an immutable lineage storage unit configured as an append-only persistent storage structure for storing chained lineage event records in chronological order; and
a deterministic replay processor configured to retrieve selected lineage event records from the immutable lineage storage unit and to reconstruct, within an isolated execution environment, a historical data processing state corresponding to the retrieved lineage event records in order to reproduce at least one historical output dataset, wherein the cryptographic chaining processor further comprises a key rotation management module configured to periodically generate new cryptographic key pairs within the tamper-resistant secure element and to embed a key transition descriptor within a lineage event record at the time of key rotation, said key transition descriptor including a signed reference to a preceding public key and a validity interval indicator, and wherein subsequent chained integrity values are computed using the newly generated cryptographic key pair while preserving verifiable linkage to lineage event records signed under preceding cryptographic keys, such that deterministic replay and integrity verification span multiple key epochs without interruption of the chained lineage sequence, and wherein the transformation interception unit further comprises an execution-layer instrumentation module embedded within the pipeline execution environment and configured to register pre-execution and post-execution hooks around each data transformation operator invocation, said instrumentation module being arranged to capture a serialized representation of input dataset states prior to execution and a serialized representation of output dataset states immediately after execution, and to compute a structural delta descriptor representing field-level additions, deletions, reordering, and datatype coercion events occurring during the transformation, and wherein the metadata extraction processor is configured to embed said structural delta descriptor within the corresponding lineage event record in association with a transformation execution sequence identifier generated for each intercepted operation, such that replay reconstruction is performed using both the transformation descriptor and the structural delta descriptor to reproduce schema evolution in a deterministic manner.

2. The system of claim 1, wherein the transformation interception unit comprises a programmable logic circuit arranged on a dedicated processing board and configured to intercept execution-level instructions corresponding to data transformation operators, including filtering operations, aggregation operations, join operations, enrichment operations, and user-defined transformation logic, and wherein the programmable logic circuit generates a transformation descriptor containing operator version identifiers, execution configuration parameters, and runtime dependency references for inclusion within each lineage event record, and wherein the metadata extraction processor is further configured to capture environmental state descriptors including software library version identifiers, container image identifiers, hardware resource allocation descriptors, and configuration file checksum values, and to associate the environmental state descriptors with the corresponding lineage event record to enable exact reconstruction of execution context during replay.

3. The system of claim 1, wherein the secure time synchronization unit comprises a trusted time source interface and a hardware validation circuit configured to prevent backward adjustment of system time, and wherein each lineage event record includes a time attestation signature generated using a protected cryptographic key stored within a tamper-resistant secure element integrated into the system, and wherein the cryptographic chaining processor is configured to compute, for each lineage event record, a first hash value over the contents of the lineage event record and a second hash value derived from a concatenation of the first hash value and a preceding chained integrity value, and to store the second hash value as part of the lineage event record to ensure sequential immutability of the lineage sequence.

4. The system of claim 1, wherein the immutable lineage storage unit comprises a segmented storage matrix organized into fixed-size lineage blocks, each lineage block containing a plurality of lineage event records and a block-level integrity hash computed over all lineage event records contained therein, and wherein each lineage block further includes a reference to a preceding lineage block to form a continuous integrity chain across the segmented storage matrix, and further comprising a lineage graph construction processor configured to transform stored lineage event records into a directed dependency graph representation in which nodes represent datasets, transformation operations, policy evaluations, and authorized actors, and edges represent data flow relationships and authorization relationships, wherein the directed dependency graph is incrementally updated in response to newly stored lineage event records.

5. The system of claim 7, wherein the lineage graph construction processor is further configured to store versioned snapshots of the directed dependency graph at predetermined intervals and to associate each snapshot with a corresponding block identifier within the immutable lineage storage unit to enable efficient retrieval of graph states corresponding to specific historical time ranges, and wherein the deterministic replay processor comprises an isolated execution container configured to replicate a historical runtime environment by loading recorded software library versions, configuration parameters, schema definitions, and input dataset hash references stored within selected lineage event records, and wherein the deterministic replay processor is further configured to execute transformation operations in a sequence strictly ordered according to the timestamps and dependency relationships recorded in the lineage event records.

6. The system of claim 9, wherein the deterministic replay processor is further configured to compute verification hash values for output datasets generated during replay and to compare the verification hash values with stored output dataset hash values contained in corresponding lineage event records, and to generate a discrepancy record within the immutable lineage storage unit if a mismatch is detected.

7. The system of claim 2, wherein the programmable logic circuit of the transformation interception unit further comprises an instruction fingerprinting sub-module configured to compute an execution fingerprint derived from a normalized representation of transformation bytecode, operator configuration parameters, and referenced dependency libraries, said execution fingerprint being generated prior to execution and stored within the lineage event record, and wherein the deterministic replay processor is configured, during reconstruction, to validate the execution fingerprint against a locally computed fingerprint of the replayed transformation instruction set before permitting execution, and to suspend replay in response to a mismatch between the stored and locally computed execution fingerprints.

8. The system of claim 3, wherein the secure time synchronization unit further comprises a distributed time attestation interface configured to periodically reconcile the hardware-based clock source with at least one external trusted time authority through a signed time beacon exchange protocol, and wherein the monotonic time validation circuit is configured to record a time drift vector representing deviation between the hardware-based clock source and the trusted time authority, and to append said time drift vector to each lineage event record generated within a reconciliation interval, such that deterministic replay incorporates recorded temporal offsets to reproduce time-dependent transformation behaviors executed under the original temporal conditions.

9. The system of claim 4, wherein the immutable lineage storage unit further comprises a write-ahead lineage buffer configured to temporarily stage newly generated lineage event records in volatile memory, and a commit controller configured to aggregate staged lineage event records into a lineage block only after verification of sequential chained integrity values and time attestation signatures, and wherein the commit controller is further configured to atomically persist the lineage block and its associated block-level integrity hash within the segmented storage matrix using a transactional write protocol that prevents partial block persistence in the event of interruption, thereby preserving ordered continuity of the chained lineage sequence.

10. The system of claim 4, wherein the lineage graph construction processor further comprises a dependency resolution engine configured to parse transformation identifiers and input-output dataset identifiers contained within the lineage event records to construct adjacency mappings, and to compute transitive dependency paths representing indirect data derivations across multiple transformation stages, and wherein said dependency resolution engine incrementally updates node-level provenance attributes including cumulative transformation depth, upstream policy inheritance flags, and actor access lineage vectors, and stores said node-level provenance attributes within an indexed graph state repository associated with the immutable lineage storage unit to facilitate selective replay of only those transformation branches affecting a specified output dataset.

11. The system of claim 5, wherein the deterministic replay processor further comprises an execution state virtualization controller configured to allocate isolated compute, memory, and storage resources corresponding to hardware resource allocation descriptors captured within the environmental state descriptors of the lineage event records, and to instantiate a containerized runtime image reconstructed from recorded container image identifiers and configuration file checksum values, and wherein the deterministic replay processor sequentially restores intermediate dataset states by resolving input dataset hash references to immutable dataset snapshots stored in association with the lineage event records prior to executing each transformation operation in accordance with recorded dependency relationships.

12. The system of claim 6, wherein the deterministic replay processor further comprises an intermediate state verification module configured to compute incremental verification hash values after execution of each replayed transformation operation and to compare said incremental verification hash values with corresponding intermediate output dataset hash values stored in the immutable lineage storage unit, and wherein upon detection of a mismatch the intermediate state verification module generates a divergence descriptor identifying the transformation execution sequence identifier, the mismatched dataset identifier, and a computed structural delta between expected and actual outputs, and appends said divergence descriptor as a new lineage event record to the immutable lineage storage unit while preserving the original chained integrity sequence.

13. The system of claim 1, further comprising a policy enforcement correlation processor operatively coupled to the metadata extraction processor and configured to intercept and record authorization context information including role identifiers, access control policy versions, and credential validation results active at the time of transformation execution, and to generate a policy evaluation trace descriptor representing rule evaluation paths and decision outcomes associated with each transformation operation, and wherein the deterministic replay processor is configured to reconstruct the historical authorization environment by loading recorded role definitions and policy versions and re-executing the recorded rule evaluation paths prior to executing corresponding transformation operations to ensure that replayed operations are executed under conditions replicating the original authorization context.
